(19) United States
(12) Patent Application Publication
(10) Pub. No.: US 2018/0006510 A1
(43) Pub. Date: Jan. 4, 2018

(54) ELECTRICAL MACHINE

(71) Applicant: RELIAX MOTORES SA de CV, VILLA DE GARCIA (MX)

(72) Inventors: MICHAEL J. VAN STEENBURG, GARDEN RIDGE, TX (US); GUSTAVO LOPEZ, GUADALUPE (MX)

(21) Appl. No.: 15/636,313

(22) Filed: Jun. 28, 2017

Related U.S. Application Data
(60) Provisional application No. 62/355,716, filed on Jun. 28, 2016.

(51) Int. Cl. H02K 1/14; H02K 1/24; H02K 3/28; H02P 1/16

(52) U.S. Cl. CPC H02K 1/141; H02P 1/163; H02K 1/246; H02K 3/28

(57) ABSTRACT

Electric machines may be attained by a variety of systems, processes, and techniques. In particular implementations, an electric machine may include a stator core composed of a variety of circumferential segments and a rotor core. In certain implementations, the stator core may include a number of individually-formed poles, each including a radially extending portion and a base portion. The base portions may be coupled together to form the stator core, and the radially extending portions may defined an inner cavity. The rotor core may include a number of radially extending poles, with the rotor sized to rotate inside the inner cavity of the stator.

### RELATED APPLICATIONS

This application claims priority to U.S. Patent Application No. 62/355,716, filed on Jun. 28, 2016. This prior application is herein incorporated by reference in its entirety.

### BACKGROUND

Electrical machines can be divided into general types based on the direction of their magnetic flux as it flows through the ferromagnetic material of the machine compared with the direction of the electric current flowing through its coils.

The most common type of electrical machine is the radial flux machine. This machine has a plurality of coils spaced around the perimeter of the machine's stator core, with the direction of the current running substantially parallel to the radial axis of the machine stator. The magnetic flux generated by the coils and ferromagnetic stator flows from the stator core radially inward, or outward depending on the machine architecture, toward the machine's rotor core.

FIG. 1 shows a simplified cross-sectional view of an example 4-phase, radial flux, switched reluctance motor 10. In particular, motor 10 includes a stator core 11 and a rotor core 15, with the rotor core located inside the inner circumference of the stator core. The stator core 11 includes eight primary phase coils 12 (two for each phase) wrapped around eight primary poles 13, and the rotor core 15 includes and six rotor poles 16. As the nomenclature implies, the stator core 11 is held against rotation while the rotor core 15 rotates, in this around a central rotatable shaft 17 that extends along the central axis of the electric machine (i.e., into the page). In operation, the motor 10 has a flux path that extends across the diameter of the rotor core 15 and around the circumference of the stator core 11.

The stator core of an electrical machine is most commonly made by forming a number of circular or square laminations with a circular area for the rotor to rotate in and then stacking those laminations to form a monolithic core structure. The manufacturing of the stator laminations typically involves cutting out the shape of the stator core from a single lamination sheet.

The second most common type of electrical machine is the axial flux machine. This machine has a plurality of coils spaced around the perimeter of the stator core as in the radial flux machine, with the exception of the stator coils being wound around primary poles in the same plane as the diametrical plane of the electrical machine, as viewed in a cross-section of the axial flux machine. The magnetic flux flows substantially parallel to the radial axis of the machine, while the current flows through the coils radially inward and outward from the radial axis of the machine.

FIG. 2 shows a simplified view of a portion of an example 3-phase, axial flux, switched reluctance motor 20. In particular, motor 20 includes a stator core 22 having six phase coils 23 wrapped around six poles 24. The rotor assembly, which is not shown for clarity, typically resembles the stator core except for not having phase coils. In operation, the motor 20 has a flux path that extends across the diameter of the rotor assembly and around the circumference of the stator core 22.

The third type of electrical machine is the transverse flux machine. This machine type is relatively new in the market and is characterized by a singular per phase circumferentially wound coil that is in the same plane of the stator diameter, as viewed in a cross-section of the machine but concentric to the stator axis. The single coil per phase is surrounded in a torus fashion by the stator and rotor poles of the machine enabling the magnetic flux to flow either radially or axially depending on machine configuration.

### SUMMARY

Electric machines may be attained by a variety of systems, processes, and techniques. In one general implementation, an electric machine may include a stator core composed of a number of circumferentially-coupled segments and a rotor core.

In particular implementations, an electric motor may include a stator core having a number of individually-formed primary poles. Each primary pole may include a radially extending portion and a base portion. The base portions may be coupled together to form the stator core, and the radially extending portions may define an inner cavity. The rotor core may include a number of radially extending poles, with the rotor sized to rotate inside the inner cavity of the stator.

In certain implementations, the primary poles may include electrical coils that wind radially relative to the rotor core from the outside of the stator core to the inside of the stator core. In some implementations, the primary poles are C-shaped. The magnetic flux generated by one of the primary poles may travel circumferentially around the rotor core from one rotor pole to an adjacent rotor pole.

In some implementations, the stator core may include a number of individually-formed secondary poles positioned between the primary poles. The primary poles may be attached to the intervening secondary poles to form the stator core. The secondary poles may include coils that wind radially relative to the rotor from the outside of the stator core to the inside of the stator core.

In particular implementations, at least one of the secondary poles has a radially extending member and a base portion. The radially extending member may be asymmetric in configuration such that the secondary pole generates a stronger magnetic flux nearer to one adjacent primary pole than another adjacent primary pole. In certain implementations, the secondary pole may include an end that is notched. In some implementations, the radially extending member of the secondary pole is located nearer to one adjacent pole than to another adjacent pole.

Various implementations of electrical machines may include one or more features. For example, by individually forming the primary poles and then winding them before coupling them together, the amount of wire for each primary pole, and hence the power produced thereby, may be increased. Thus, the power that may be generated by the motor based on its volume may be increased. Additionally, the assembly allows the secondary poles to be formed and wound individually.

As another example, an electrical machine may have a relatively short magnetic flux path. In general, the length of the magnetic flux path through the stator core and the rotor core is a function of machine architecture and is substantially responsible for the commutation switching frequency of the electrical machine and the core losses in an electrical machine. The most common motor types have a flux path that flows radially towards or away from the center of the rotor diameter and then circumferentially around the stator core to complete the magnetic flux loop. The longer the flux path loop, the greater the commutation switching frequency required for a specific rotational speed and the greater the core losses for the electrical machine. It is therefore desirable for an electrical machine to have a short flux path in order to reduce core losses and reduce commutation switching frequency.

Various other features will be evident to those of skill in the art based on the following detailed description and drawings.

### BRIEF DESCRIPTION OF THE DRAWINGS

FIG. 1 is a line drawing illustrating a cross section of an embodiment of a conventional 4-phase, radial flux, switched reluctance motor.

FIG. 2 is a line drawing illustrating a cross section of an embodiment of a conventional 3-phase, axial flux, switched reluctance motor.

FIG. 3 is a line drawing illustrating a cross section of an example implementation of a radial-flux, switched reluctance motor.

FIG. 4 is a line drawing illustrating a perspective view of the motor in FIG. 3, with the housing removed.

FIG. 5 is a line drawing illustrating a perspective view of the motor in FIG. 3, with the housing and coils removed.

FIG. 6 is a control schematic implementation for a 2½ phase motor.

FIG. 7 is a line drawing illustrating an implementation a 1½ phase motor.

FIGS. 8A-B illustrate example configurations for secondary poles for a switched reluctance motor.

FIG. 9 is a control schematic implementation for a 1½ phase motor.

### DETAILED DESCRIPTION

The following discussion is directed to various implementations. Although one or more of these implementations may be preferred, the implementations disclosed should not be interpreted, or otherwise used, as limiting the scope of the disclosure, including the claims. In addition, one skilled in the art will understand that the following description has broad application, and the discussion of any implementation is meant only to be exemplary of that implementation, and not intended to intimate that the scope of the disclosure is limited to that implementation.

Certain terms are used throughout the following description and claims to refer to particular system components. As one skilled in the art will appreciate, different companies may refer to a component by different names. This document does not intend to distinguish between components that differ in name but not function.

In the following discussion and the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection or through an indirect connection via other devices and connections.

“Motor” shall mean either a device that creates mechanical energy from electrical energy or a device that creates electrical energy from mechanical energy. Thus, reference to a “motor” shall not exclude the possibility of generator operations.

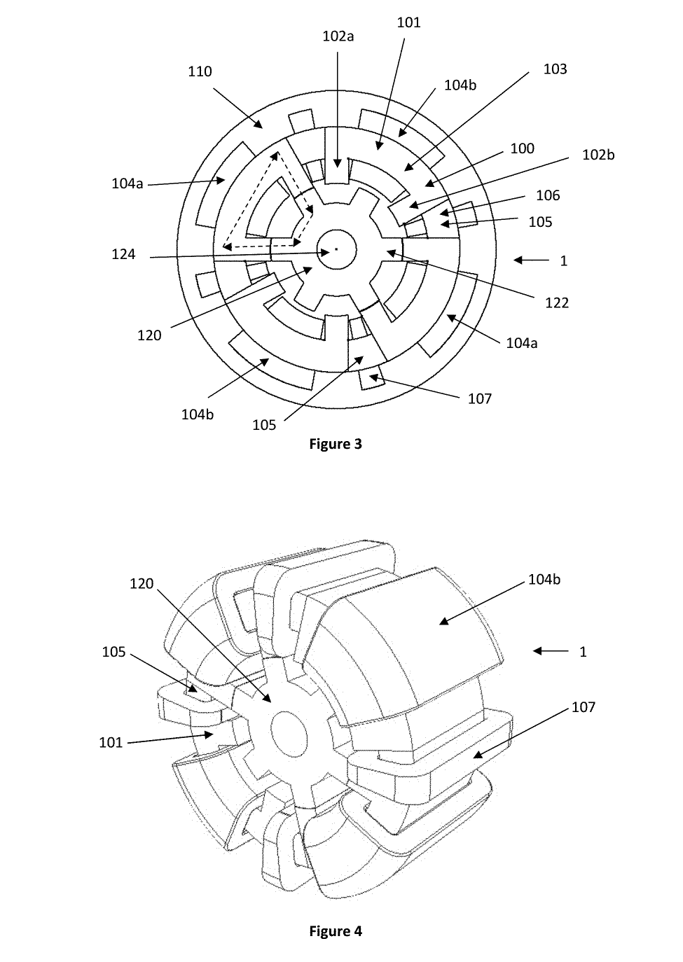

FIGS. 3-5 illustrate an example radial-flux, switched reluctance motor 1. In particular, motor 1 is a 2½ phase switched reluctance motor with a radial flux architecture. The manufacturing and assemblage techniques for motor 1 discussed herein may be used for other types of radial flux motors and/or other types of switched reluctance motors.

Among other things, motor 1 includes a stator core 100 and a rotor core 120. Stator core 100 includes four primary poles 101 and four secondary poles 105. During manufacture, the primary poles 101 and the secondary poles 105 are formed separately from each other and then joined together (e.g., circumferentially) to form stator core 100.

The poles may, for example, be made of a soft magnetic material. In certain implementations, the magnetic material may be a composite material. For example, an individual pole may be a stacked assembly of cut-to-shape laminations that are placed together (e.g., bonded) to form the pole. The thickness of the primary poles 101 and the secondary poles 105 typically varies depending on the required torque. In typical implementations, the poles may be from a few millimeters to several hundred millimeters thick.

In particular implementations, each primary pole 101 and secondary pole 105 may be individually made of multiple laminations of electrical steel. For example, one or more layers may be composed of 29 gauge M19 Silicon Steel that has been punched from a larger sheet. The laminations be may be glued, staked, or welded together to form a pole.

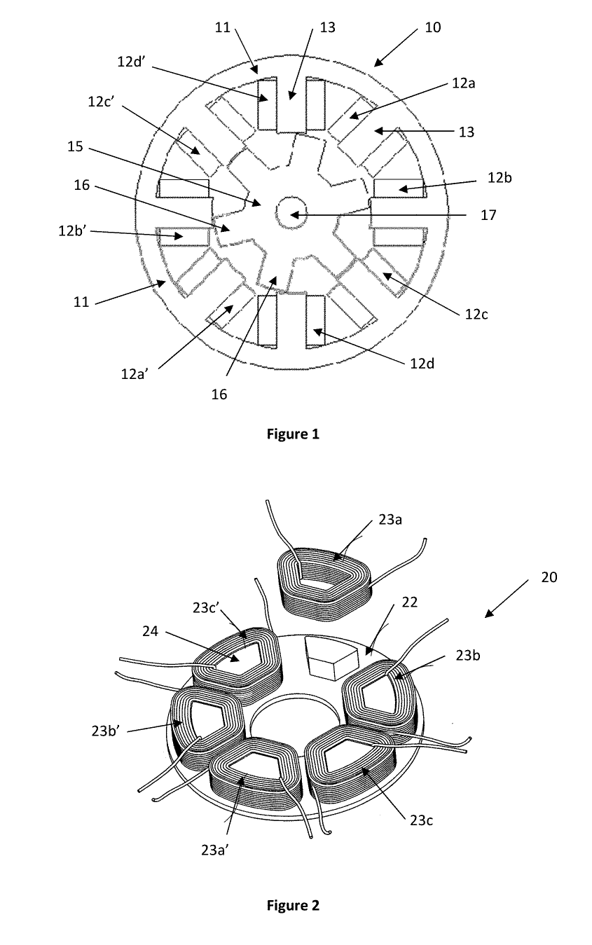

As illustrated, each primary pole 101 includes two radially extending members 102a-b and a base portion 103, which is wound with a primary phase coil 104, resulting in primary poles 101 having a C-shape. Other shapes for the primary pole may be used in other embodiments. The secondary poles 105 include a base portion 106, which is wound with a secondary phase coil 107. Instead of being wrapped around an inner portion of the corresponding pole as in FIG. 1, however, coils 104, 107 are wrapped from the outside to the inside of the stator core 100 (i.e., around the circumference of the stator core). The electrical coils may, for example, be made of copper, aluminum, or litz wire.

The primary phase coils 104 may be concentrated windings that are wrapped around the primary poles 101 prior to the primary poles being joined together with the secondary poles 105. In a similar fashion, the secondary phase coils 107 may be concentrated windings that are wrapped around the secondary poles 105 prior to the secondary poles being joined together with the primary poles 101 to form the stator core.

The rotor core 120 is shown located in the center of the stator core 100 and includes six poles 122. The rotor core 120 may be made of laminated electrical steel or soft magnetic composite (smc). The poles 122 of the rotor core 120 may have a gap (often referred to as an “air gap”) between their ends and the ends 102 of the primary poles 101. The gap depends on the size and efficiency of the motor. In general, it ranges from about 0.003 mm to about 6.0 mm. In particular implementations, the gap is on the order of 0.2 mm. The rotor rotates on a shaft 124 that runs into and out of the page for FIG. 3. The shaft 124 may, for example, be made of aluminum or steel and may be solid or hollow. The shaft may rotate on a bushing or bearing on one or more ends.

The primary poles 101 and the secondary poles 105 may be coupled to each other by an external housing, interlocking, and/or being welded together. In the illustrated implementation, the primary poles 101 and the secondary poles 105 are welded together, by electrical arc welding techniques, for example (e.g., by tig or mig). After assembly, the inner portions of the poles may be honed to provide a cavity with a tight tolerance. The outside of the rotor may be machined (e.g., ground) to provide a tight tolerance rotation.

Motor 1 also includes a housing 110. The housing 110 protects coils 104, 107 from damage and prevents accidental contact with them by humans. Housing 110 may, for example, be made of aluminum or iron. In particular implementations, housing 110 may provide water cooling or air cooling to the motor 1.

As illustrated, the motor 1 is a short flux path electrical machine, wherein the magnetic flux is restricted from passing through the center of the rotor 102 by virtue of the configuration of the primary poles 101. In particular, the magnetic flux of a primary pole 101 passes out from one end 102 of the primary pole into a rotor pole 122, travels to the next rotor pole 122, and enters the other end 102 of the primary pole. Motor 1 operates in an asynchronous manner.

In operation, the primary commutation strokes of the motor 1 are borne by the two primary phase coils 104, which themselves are composed of two electrically parallel coils diametrically opposed from each other across the circumference of the electrical machine in this embodiment. The operation of the motor 1 described herein is such that the secondary poles 105 are utilized whenever the commutation stroke of the electrical motor is insufficient based on desired performance.

For example, the motor 1 may use the secondary poles 105 to start the motor. Activating the secondary poles 105 ensures that the poles 122 of the rotor core 120 are not aligned with the primary poles 101, which might prevent motor 1 from starting. Once the rotor core 120 is turning, the primary poles 101 may be activated in sequence to pull the poles 122 of the rotor core 120 around. The secondary poles 105 may be activated for additional power during high load conditions.

The rotational position of the rotor core 120, which is needed for determining when to activate the coils 104, may be determined with various types of sensors. For example, the rotational position of the rotor core 120 may be determined with a Hall-effect sensor or an optical sensor. In particular implementations, the position of the rotor core may be determined from reading the inductance in a circuit. For example, when a pole of the rotor core approaches a primary pole, the inductance should increase, and when the pole of the rotor core departs from a primary pole, the inductance should decrease.

Motor 1 has a variety of features. For example, by individually forming the primary poles 101 and then winding them before coupling them together, the amount of wire for each primary pole, and hence the power produced thereby, may be increased. Thus, the power that may be generated by the motor based on its volume may be increased. Additionally, the assemblage allows the secondary poles to be formed and wound individually.

As another example, by forming the stator core from individual pole segments, material waste may be reduced (e.g., by interlacing different pieces of a segment with each other during punch out). Typical manufacturing of stator laminations involves cutting out the entire shape of the stator from a single lamination sheet, which leaves a substantial amount of unused material that is discarded (e.g., 20-30%). The segmented stator core, however, uses smaller segments of the typical stator lamination that are stacked into cores, and then the core segments are joined together circumferentially to form the complete stator core shape. This method of manufacture enables less material waste (e.g., 5-10%) and smaller machines required for stator core manufacturing. There may also be some benefits to coil slot fill factor and the allowance of stator core structures that would otherwise be difficult to manufacture an electrical machine from.

As a further example, the motor 1 has a relatively short magnetic flux path. In general, the length of the magnetic flux path through the stator core and the rotor core is a function of machine architecture and is substantially responsible for the commutation switching frequency of the electrical machine and the core losses in an electrical machine. The most common motor types have a flux path that establish a North-South pole arrangement that is diametrically opposed across the circumference of the stator diameter. The magnetic flux therefore flows radially towards or away from the center of the rotor diameter and then circumferentially around the stator core to complete the magnetic flux loop. The longer the flux path loop, the greater the commutation switching frequency required for a specific rotational speed and the greater the core losses for the electrical machine. It is therefore desirable for an electrical machine to have a short flux path in order to reduce core losses and reduce commutation switching frequency.

Although FIGS. 3-5 illustrate an example electrical motor, other electric motors in accordance with the invention may have different configurations. For example, a motor may have eight poles on the rotor core, rendering it a 1.5 phase motor. The motor may also operate in a synchronous manner. Additionally, other motors may not have a housing. Additionally, a rotor may be made of individual segments.

Although FIGS. 3-5 illustrate a radial flux machine architecture, this focus on the radial flux machine architecture does not preclude the components and assembly techniques from being extended into any other machine architectures (e.g., axial flux) or pole/rotor configurations. Additionally, the ½ phase poles are not necessary.

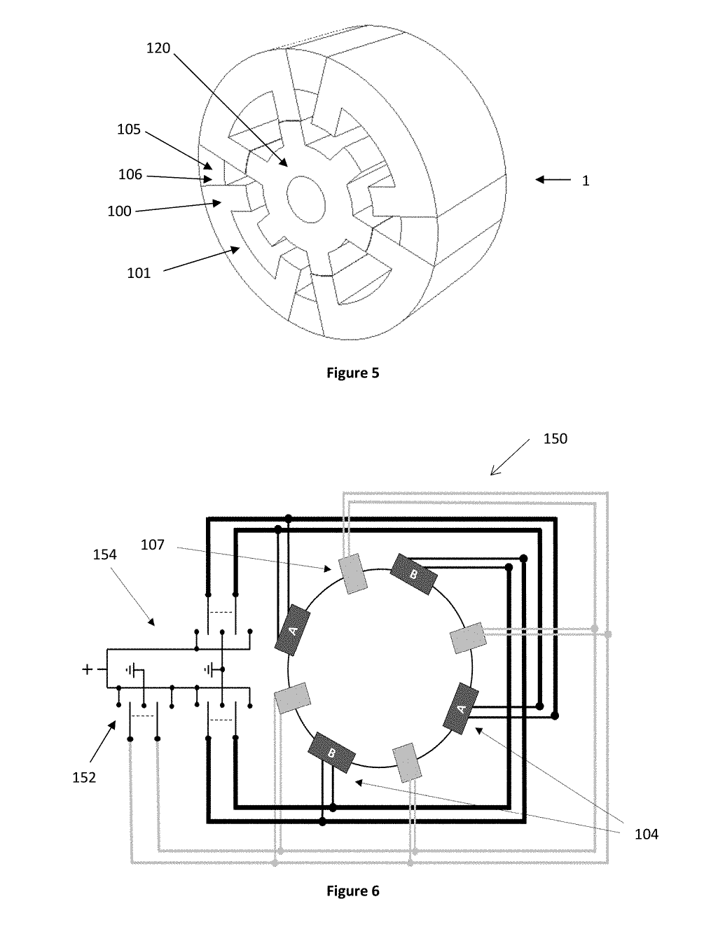

FIG. 6 shows an example control schematic layout 150 for a 2½ phase motor. In particular, this implementation shows the “½ phase” coils and the method in which they are connected to the primary phase coils by way of a power control switch 152 that is controlled by a separate logic control device and algorithm (not shown). The primary coils are excited in a similar manner by their own separate power control switch 154 that is also controlled by a separate logic control device and algorithm. The control of the coils may, for example, be provided by a conventional algorithm.

FIG. 7 illustrates an example implementation of a 1½ phase motor 2. Similar to motor 1, motor 2 has a stator core 101′ and a rotor core 120′. The stator core 101′ has four individually-formed primary poles 101′, with the primary phase coils 104 wrapped from the inside to the outside of the stator core, and four individually-formed secondary poles 105′. The primary phase coils 104 are electrically connected in series or parallel depending on the desired performance parameters of the motor. The secondary poles 105′ have a base portion 106 and a radially extending portion 108, with secondary phase coils 107′ wrapped therearound on the inside of the stator core 101′. The second phase coils 107′ are controlled separately, but connected to the same power source. The shape of the secondary poles 105′ for the secondary phase coils 107′ is different from that in motor 1, but still has the same basic function.

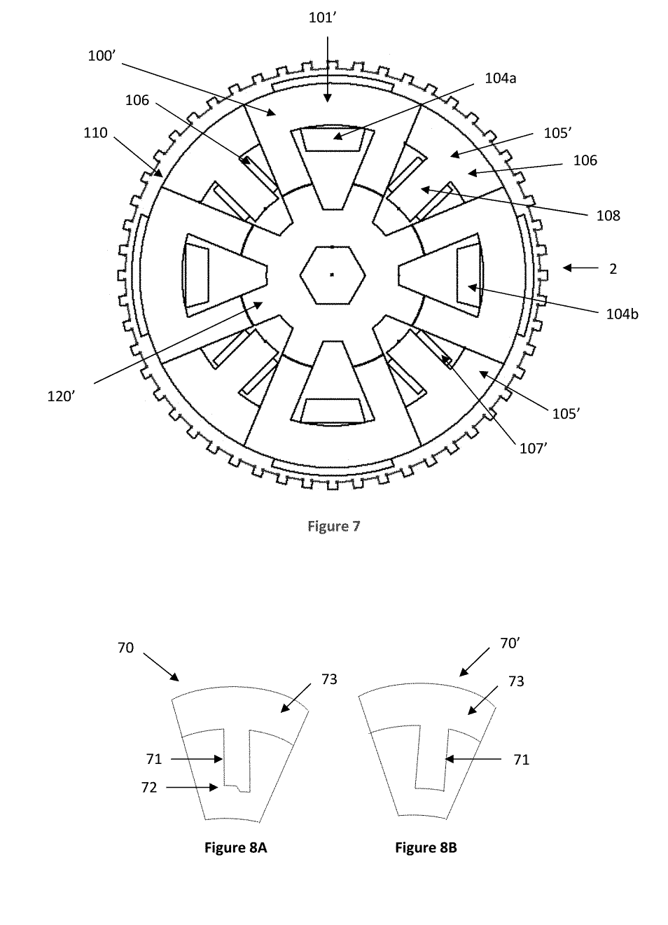

FIGS. 8A-B illustrate example configurations of secondary poles for a switched reluctance motor. Secondary poles 105′ in FIG. 7 are symmetric with each respect to each other and their base portions. In FIGS. 8A-B, however, secondary poles 70, 70′ are asymmetric to ensure rotation start up in a specific direction. In particular, secondary pole 70 has a notch in end 72 of its radially extending portion 71. This creates a distortion in the magnetic flux field that makes the rotor want to align in an offset direction from the secondary pole and be closer to one primary pole than the other. Thus, when the primary poles are activated, the rotor should rotate in a specific direction. Secondary pole 70′, on the other hand, is offset from the middle of its base portion 71. Thus, it also generates a magnetic flux that ensures the poles of the rotor will be drawn closer to one primary pole than the other. Thus, when the primary poles are activated, the rotor core should rotate in a specific direction. In general, the secondary poles may have any shape to assure that the rotor core starts turning in a particular direction.

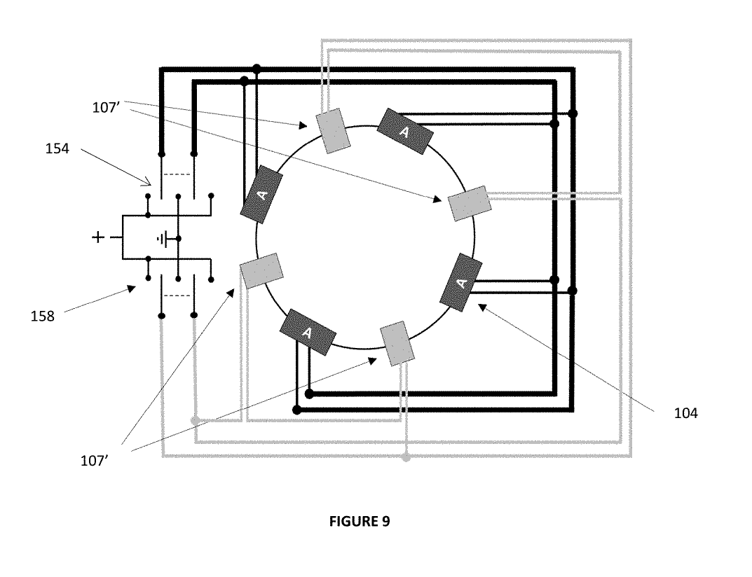

FIG. 9 depicts an example control schematic for a 1½ phase motor. Noticeable differences include the implementation having all of the primary phase coils 104 connected in series or alternately in parallel. The secondary phase coils 107′ are connected to separate power switches much like a polyphase motor controller would contain, except that in the present implementation the secondary phase coils are controlled by a much simpler power control switching device 158. The primary phase coils 104 in the illustrated implementation are connected in parallel; however, it is possible to connect the primary phase coils 104 in series as well for yet another alternate design.

What is claimed is:

1. An electric motor comprising:
a stator core including a number of individually-formed primary poles, each primary pole including a radially extending portion and a base portion, the base portions being coupled together to form the stator core, and the radially extending portions defining an inner cavity; and
a rotor core comprising a number of radially extending poles, the rotor sized to rotate inside the inner cavity of the stator.

2. The electric motor of claim 1, wherein the primary poles comprise electrical coils that wind radially relative to the rotor core from the outside of the stator core to the inside of the stator core.

3. The electric motor of claim 2, wherein the poles are C-shaped.

4. The electric motor of claim 3, wherein the magnetic flux generated by one of the primary poles travels circumferentially around the rotor core from one rotor pole to an adjacent rotor pole.

5. The electric motor of claim 2, further comprising a housing that covers the outside portions of the coils.

6. The electric motor of claim 1, wherein the magnetic flux generated by one of the primary poles travels circumferentially around the rotor core from one rotor pole to an adjacent rotor pole.

7. The electric motor of claim 1, wherein the stator core comprises a number of individually-formed secondary poles, the secondary poles positioned between the primary poles.

8. The electric motor of claim 7, wherein the secondary poles comprise coils that wind radially relative to the rotor from the outside of the stator core to the inside of the stator core.

9. The electric motor of claim 7, wherein the primary poles are attached to the intervening secondary poles to form the stator core.

10. The electric motor of claim 7, wherein at least one of the secondary poles has a radially extending member and a base portion.

11. The electric motor of claim 10, wherein the radially extending member is asymmetric in configuration such that the secondary pole generates a stronger magnetic flux nearer to one adjacent primary pole than another adjacent primary pole.

12. The electric motor of claim 11, wherein the secondary pole has an end that is notched.

13. The electric motor of claim 11, wherein a radially extending member of the secondary pole is located nearer to one adjacent pole than to another adjacent pole.

14. The electric motor of claim 1, wherein at least one of the primary poles comprises a number of stamped pieces that have been assembled together to form the pole.
